(19) United States
(12) Patent Application Publication
(10) Pub. No.: US 2008/0197082 A1
(43) Pub. Date: Aug. 21, 2008

(54) Aminocarboxylic Acid Esters Having Eo/Po/Buo-Blockpolymers and Use Thereof as Demulsifiers

(75) Inventors: Marcus Guzmann, Muhlhausen (DE); Peter Neumann, Mannheim (DE); Karl-Heinz Buchner, Altlussheim (DE); Alfred Oftring, Bad Durkheim (DE)

Correspondence Address: CONNOLLY BOVE LODGE & HUTZ LLP, 1875 EYE STREET, N.W., SUITE 1100, WASHINGTON, DC, 20036, US

(73) Assignee: BASF AKTIENGESELLSCHAFT, Ludwigshafen (DE)

(21) Appl. No.: 11/917,829

(22) PCT Filed: Jun. 14, 2006
(86) PCT No.: PCT/EP06/63239

§ 371 Date: Dec. 17, 2007

(30) Foreign Application Priority Data
Jun. 17, 2005 (DE) 102005028500.7

(51) Int. Cl. B01D 17/04; C08G 65/00

(52) U.S. Cl. 210/708; 528/403

(57) ABSTRACT

The present invention relates to aminocarboxylic esters with EO/PO/BuO block polymers, processes for preparing such compounds and the use of these compounds as emulsion breakers, in particular for crude oil emulsions.

The present invention relates to aminocarboxylic esters with EO/PO/BuO block polymers, processes for preparing such compounds and the use of these compounds as emulsion breakers, in particular for crude oil emulsions.

Petroleum is generally obtained as a relatively stable water-in-oil emulsion. This can, depending on age and reservoir, comprise up to 90% by mass of water. The composition of crude oil emulsions differs from reservoir to reservoir. Apart from water, the crude oil emulsion generally further comprises from 0.1 to 25% by mass of salts and solids. Water, salts and solids have to be removed before the crude oil emulsion can be transported and processed as crude oil in the refinery. The crude oil itself is a heterogeneous mixture and comprises, in particular, natural emulsifiers such as naphthenic acids, heterocyclic nitrogen compounds and oxidized hydrocarbons, also petroleum colloids such as asphaltenes and resins, inorganic salts such as iron sulfides, iron oxides, clays and ores, sodium chloride and potassium chloride.

Breaking of the crude oil emulsion is carried out for economic and technical reasons, firstly to avoid the uneconomical transport of water, to prevent or at least minimize corrosion problems and to reduce energy consumption for the transport pumps.

The breaking of the crude oil emulsion is thus an important process step in petroleum recovery. The water comprised in the crude oil, which is emulsified, in particular, by natural emulsifiers such as naphthenic acids, forms a stable emulsion. This occurs because the emulsifiers reduce the interfacial tension between the water phase and oil phase and thus stabilize the emulsion. Addition of emulsion breakers (demulsifiers), i.e. surface-active substances which penetrate into the oil/water interface and there displace the natural emulsifiers, can effect coalescence of the emulsified water droplets, which finally leads to phase separation.

EP-A-0 264 841 describes the use of linear copolymers of hydrophobic acrylic or methacrylic esters and hydrophilic ethylenically unsaturated monomers as petroleum emulsion breakers.

EP-A 0 499 068 describes the preparation of reaction products of vinylic monomers and alcohol alkoxylates or phenol alkoxylates and their use as demulsifiers for crude oil emulsions.

U.S. Pat. No. 5,460,750 describes reaction products of phenolic resins and alkylene oxides as emulsion breakers for crude oil emulsions.

EP-A 0 541 018 describes emulsion breakers prepared from polyethyleneimines having a mean molar mass of 35,000 g/mol and ethylene oxide and propylene oxide, with an alkylphenol-formaldehyde salt being additionally used as second active component.

EP-A 0 784 645 describes the preparation of alkoxylates of polyamines, especially polyethyleneimines and polyvinylimines and their use as crude oil emulsion breakers.

EP-A 0 267 517 discloses branched polyamino esters as demulsifiers. The branched polyamino esters are obtained by reaction of alkoxylated primary amines with triols and dicarboxylic acids.

Furthermore, dendritic polymers are described as demulsifiers for crude oil.

U.S. Pat. No. 4,507,466 and U.S. Pat. No. 4,857,599 disclose dendritic polyamidoamines. U.S. Pat. No. 4,568,737 discloses dendriteric polyamidoamines and hybrid dendrimers made up of polyamidoamines, polyesters and polyethers, and their use as demulsifiers for crude oil. The preparation of dendrimers is very complicated, which is why these products are very expensive and can thus not be used economically in industrial quantities.

It is therefore an object of the present invention to provide compounds which can be used for breaking emulsions, in particular crude oil emulsions. These compounds should be able to be prepared simply and inexpensively. They should have good demulsifying properties, ideally better demulsifying properties than the known systems, and they should if possible be biodegradable.

This object is surprisingly achieved by the compounds according to claims 1 to 6, the preparative processes according to claims 7 to 9, and the use of the compounds according to claims 10 and 11. The present invention further provides a composition according to claim 12, a kit of parts according to claim 13, a method of separating off water according to claim 14 and an oil according to claims 15 and 16.

The present invention thus provides, firstly, a compound of the formula

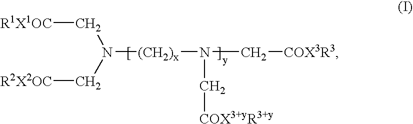

where
x is from 2 to 10,
y is from 0 to 10,
R¹, R², R³, . . . , R^{3+y} are each, independently of one another,

—[(EO)ₖ^{(1, . . . , t)}—(PO)ₘ^{(1, . . . , t)}—(BuO)ₙ^{(1, . . . , t)}]ₜ—R^{z},

the indices k^{(1, . . . , t)} in the t sections are each, independently of one another, from 0 to 200,
the indices m^{(1, . . . , t)} in the t sections are each, independently of one another, from 0 to 200,
the indices n^{(1, . . . , t)} in the t sections are each, independently of one another, from 0 to 200,
t is from 1 to 20,
R^{z} is H, alkyl, cycloalkyl, heteroalkyl, heterocycloalkyl, aryl, aralkyl or heteroaryl,
X¹, X², X³, . . . , X^{3+y} are each, independently of one another, —O—, —NH— or —NR^{z}—,
with the proviso that
when x=2 and y=1,
in at least one R¹, R², R³ or R^{3+y}, at least one k^{(1, . . . , t)} or n^{(1, . . . , t)} is not 0, und in all other cases, at least one k^{(1, . . . , t)} or m^{(1, . . . , t)} or n^{(1, . . . , t)} is not 0.

Here, preference is given to a compound as mentioned above in which, independently of one another,

x is from 2 to 6,
y is from 0 to 5,
the indices k^{(1, . . . , t)} in the t sections are each, independently of one another, from 0 to 100,
the indices m^{(1, . . . , t)} in the t sections are each, independently of one another, from 0 to 100,
the indices n^{(1, . . . , t)} in the t sections are each, independently of one another, from 0 to 100,
t is from 1 to 10,
R^{z} is H or alkyl, cycloalkyl, heteroalkyl, heterocycloalkyl, aryl, aralkyl or heteroaryl having from 1 to 20 carbon atoms,
each X¹, X², X³, . . . , X^{3+y} is —O—, —NH— or —NR—.

A compound as mentioned above in which, independently of one another,

x is 2,
y is 0, 1 or 2,
the indices k^{(1, . . . , t)} in the t sections are each, independently of one another, from 0 to 50,
the indices m^{(1, . . . , t)} in the t sections are each, independently of one another, from 0 to 50,
the indices n^{(1, . . . , t)} in the t sections are each, independently of one another, from 0 to 50,
t is from 1 to 5,
R^{z} is H or alkyl, cycloalkyl, heteroalkyl, heterocycloalkyl, aryl, aralkyl or heteroaryl having from 1 to 10 carbon atoms,
X¹, X², X³, . . . , X^{3+y} is —O—, is particularly preferred and a compound in which, independently of one another,
y=1,
the indices k^{(1, . . . , t)} in the t sections are each, independently of one another, from 0 to 30,
the indices m^{(1, . . . , t)} in the t sections are each, independently of one another, from 0 to 30,
the indices n^{(1, . . . , t)} in the t sections are each, independently of one another, from 0 to 30,
t=1, 2 or 3,
R^{z} is H or alkyl having from 1 to 5 carbon atoms, is very particularly preferred.

In particular, compounds in which

a) t=1 and
(i) k¹=0 or
(ii) m¹=0 or
(iii) n¹=0; or

b) t=2 and
(i) k¹=0, m¹ and k² are not 0 or
(ii) k¹ and m¹=0, n¹ is not 0 and k² is not 0 or
   k¹ and m¹=0, n¹ is not 0 and m² is not 0,
      represent preferred embodiments of the present invention.

Very particular preference is given to a compound in which each k^{(1, . . . , t)} or each m^{(1, . . . , t)} or each n^{(1, . . . , t)}=0.

All numbers x, y, k¹, k², . . . , k^{t}, m¹, m², . . . , m^{t}, n¹, n², . . . n^{t} and t in each individual molecule are integers. However, since the compounds of the invention comprise constituents having oligomeric and/or polymeric character, i.e. comprise substituents which have or at least can have a particular length distribution, fractional values are also possible. If, for example, y=0, R¹═R²═R³═—[(EO)ₖ^{(1, . . . , t)}]-R^{z} since m=n=0 and k¹ is 10, k² is 12 and k³ is 13, a mean value of k=11.67 will be given to describe the molecule. Thus, not only integers are possible as numerical values; and if mixtures of a plurality of molecules are present, the numerical values determined for such mixtures are equal to the numerical values determined for individual molecules.

Particular base molecules are, as indicated above, particularly preferred. Thus, when y=0, the base molecule is nitrilotriacetate (NTA), when y=1, the base molecule is ethylenediaminetetraacetate (EDTA) and when y=2, the base molecule is diethylenetriaminepentaacetate (DTPA).

Preference is likewise given to compounds in which the units EO (ethylene oxide), PO (propylene oxide) and/or BuO (butylene oxide) are present essentially in block form. The order of the blocks can also vary. Thus, orders in the sequence from the base molecule to R^{z} which may be used are EO-PO, EO-BuO, PO-EO, PO-BuO, BuO-EO, BuO-PO, EO-PO-EO, EO-PO-BuO, EO-BuO-EO, EO-BuO-PO, PO-EO-PO, PO-EO-BuO, PO-BuO-EO, PO-BuO-PO, BuO-EO-PO, BuO-EO-BuO, BuO-PO-EO, BuO-PO-BuO, EO-PO-EO-PO, EO-PO-EO-BuO, . . . . Particular preference is given to compounds in which one or two blocks are present per R.

The present invention further provides a process for preparing compounds as described above, which comprises reacting a compound of the formula

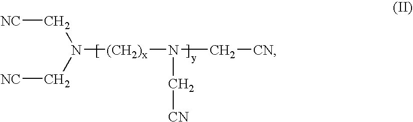

where x and y are as defined in any of claims 1 to 4,
in a first step with R¹—X¹H, R²—X²H, R³—X³H, . . . , R^{3+y}—X^{3+y}H and mineral acid and simultaneously or
in a second step with water or an aqueous base.

As mineral acid, it is possible to use any mineral acid or mixture of a plurality of these acids, with the use of HCl being particularly preferred.

As base, it is possible to use any base or mixture of bases, with particular preference being given to using NaOH.

A further process according to the invention for preparing a compound as described above is a process which comprises reacting a lower carboxylic ester or a carboxylic acid of the formula

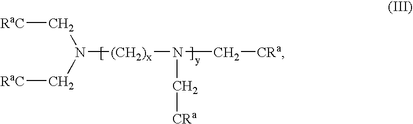

where x and y are as defined in any of claims 1 to 4 and R^{a}═C₁-C₆-alkyl, H, with alkyl polyglycol in the presence of an acid or base as catalyst.

Possible acids and bases here are those mentioned above for the alternative process. For the present purposes, a lower carboxylic ester is an ester in which the definition of R═C₁ to C₆ just given applies to the ester groups. Such esters are preferred because they make it possible to improve the way in which the process is carried out further: thus, particular preference is given to a process in which the alcohol R^{a}—OH formed, where R^{a}═C₁-C₆-alkyl, is removed by distillation.

Basically, both processes are carried out in the temperature range from −40 to 250° C., with a temperature in the range from 0 to 200° C. being preferred and a temperature in the range from room temperature to 180° C. being particularly preferred. The reactions can be carried out under atmospheric pressure, or else under superatmospheric pressure or under subatmospheric pressure. The reactions can in principle be carried out batchwise, continuously or semicontinuously. If the reactions are carried out in a plurality of steps, the individual steps can be carried out in one reaction vessel or in various reaction vessels.

The present invention further provides for the use of a compound as described above and/or a compound in which x=2 and y=1 and in which at least one m^{(1, . . . , t)} in at least one R¹, R², R³ or R^{3+y} is not 0 for separating emulsions. Particular preference is given to the abovementioned use in which the emulsion is crude oil. A further preferred use of the compounds mentioned is for separating emulsions in paper processing.

The present invention also provides a composition comprising one of the abovementioned compounds. Apart from this compound or mixture of a plurality of these compounds, the composition of the invention can comprise, for example, other demulsifiers such as those mentioned as prior art. Further constituents can be, for example, solvents such as xylene, glycol, isopropanol, methanol.

The present invention further provides a kit of parts comprising a composition as described above. Apart from other kits of parts, kit of parts which comprise firstly one of the compounds according to the invention and secondly one or more solvents and/or one or more other demulsifiers are therefore comprised.

The present invention also provides a method of separating off water from crude oil, wherein one of the above-described compounds is used. Here, the compound according to the invention is preferably added to the crude oil directly at the well head. However, it can also be added to the crude oil in separators. Multiple addition of the compounds according to the invention to the crude oil is preferred. Preference is likewise given to a method in which the compounds according to the invention are added together with the solvents mentioned to the crude oil.

The oil comprising the abovementioned compounds according to the invention is likewise subject matter of the present invention.

The oil from which at least part of the water comprised in the crude oil has been separated off by a method as described above is also subject matter of the present invention.

The present invention is illustrated below by some examples:

### EXAMPLE 1

### EDTA Tetrapolyglycol Ester

A mixture of 19.1 g (0.05 mol) of EDTA tetramethyl ester and 0.3 g of tetraisopropyl orthotitanate was heated at 50° C. while stirring vigorously and passing nitrogen over it. 327.8 g (0.2 mol) of a methylpolyalkylene glycol (MePG) having about 10 EO units and about 30 PO units (OH number: 34 mg KOH/g=0.61 mmol/g) were added dropwise over a period of 30 minutes while simultaneously increasing the temperature to 120° C. The mixture was subsequently heated at 160° C. for 6 hours and the methanol liberated in the transesterification was simultaneously distilled off.

According to GC analysis, the EDTA methyl ester had been reacted completely. The resulting yellow oil had, after cooling, an ester number of 33 mg KOH/g.

### EXAMPLE 2

### NTA Tripolyglycol Ester

Using a method analogous to the above example, 11.65 g (0.05 mol) of NTA trimethyl ester were reacted with 245.9 g (0.15 mol) of Me-PG having 10 EO units and 30 PO units and 0.3 g of tetraisopropyl orthotitanate to give the NTA PG ester. According to GC analysis, the NTA methyl ester had reacted completely after 7 hours at 160° C.

A yellowish brown oil having an ester number of 29 mg KOH/g remained.

### EXAMPLE 3

Various demulsifiers were added to a sample of crude oil and the separation properties were examined. Sepabase A 39 is a polyethyleneimine which has firstly been ethoxylated with EO and then propoxylated with PO. Sepabase R19 is a resin derived from nonylphenol ethoxylate which has been crosslinked with formaldehyde and Dissolvan is likewise a resin derived from nonylphenol ethoxylate which has been crosslinked with formaldehyde but is present in a solvent. EVD 60549 is a compound according to the invention based on EDTA, as described in Example 1. EVD 60550 is a compound according to the invention based on NTA, as described in Example 2.
Emulsion: Emlichheim, crude oil from probe 83
   (Crude oil sample of May 11, 2005)
Viscosity: 1540 mPa·s (Brookfield Sp. 3/60 rpm/at 52° C.)
Water content: 54% (Distillation method, DIN ISO 3733)
Temperature: 52° C.
Note: The additive (in each case 5% of active substance* in xylene/isopropanol 3:1) was mixed in by means of an overhead mixer after addition. For the assessment, the experiments were jiggered. (Heidolph REAX top)

| | | Water separated off (ml) | | | | | | | Emulsion [%] | |
|---|---|---|---|---|---|---|---|---|---|---|
| | *AS | after time [min] | | | | | | | after 4 h | |
| Additive | [%] | 10 | 20 | 30 | 60 | 120 | 240 | Appearance | Residual w | Residual em |
| Blank | — | 0 | 0 | 0 | 0 | 1 | 2 | clear | 48 | — |
| 25 ppm of | 100 | 2 | 3 | 4 | 11 | 17 | 21 | clear | 36 | — |
| Sepabase A 39 | | | | | | | | | | |
| EVD 57260 | | | | | | | | | | |
| 25 ppm of | 51 | 2 | 3 | 3 | 4 | 5 | 11 | clear | 8 | 20 |
| Sepabase R 19 | | | | | | | | | | |
| EVD 58490 | | | | | | | | | | |
| 25 ppm of | 45 | 3 | 4 | 4 | 6 | 12 | 36 | clear | 20 | — |
| Dissolvan 3146-3 | | | | | | | | | | |
| EVD 92750 | | | | | | | | | | |
| 25 ppm of | 90 | 15 | 36 | 40 | 42 | 43 | 44 | clear | 12 | — |
| EVD 60549 | | | | | | | | | | |
| 7078-04-033 | | | | | | | | | | |
| 25 ppm of | 90 | 1 | 2 | 2 | 3 | 4 | 7 | clear | 40 | — |
| EVD 60550 | | | | | | | | | | |
| 7078-04-038 | | | | | | | | | | |

It can be seen that both compounds according to the invention are able to separate off water from the crude oil emulsion. In the case of EVD 60549, it can also be seen that the compound according to the invention does not lead to water being separated off significantly more quickly but rather that significantly more water is separated off than by means of the demulsifiers customary hitherto.

### EXAMPLE 4

Various demulsifiers were added to a sample of crude oil and the separation properties were examined. Dissolvan is a resin derived from nonylphenol ethoxylate which has been crosslinked with formaldehyde but is present in a solvent. EVD 60549 is a compound according to the invention based on EDTA, as described in Example 1.
Emulsion: Emlichheim, mixture from probe 83+301/canister 2
   (Crude oil sample of Apr. 17, 2005)
Viscosity: 1212 mPa·s (Brookfield Sp. 3/60 rpm/at 52° C.)
Water content: 49.5% (Distillation method, DIN ISO 3733)
Temperature: 52° C.
Note: The additive (in each case 5% of active substance* in xylene/isopropanol 3:1) was mixed in by means of an overhead mixer after addition. For the assessment

| | | Water separated off (ml) | | | | | | Emulsion [%] | |
|---|---|---|---|---|---|---|---|---|---|
| | *AS | after time [min] | | | | | | after 4 h | |
| Additive | [%] | 10 | 20 | 30 | 60 | 120 | 240 | Residual w | Residual em |
| Blank | — | 0 | 0 | 0 | 2 | 3 | 5 | 28 | 24 |
| 25 ppm of | 100 | 2 | 5 | 8 | 16 | 25 | 31 | — | 32 |
| Sepabase A 39 | | | | | | | | | |
| EVD 57260 | | | | | | | | | |
| 25 ppm of | 45 | 3 | 4 | 4 | 6 | 19 | 38 | — | 20 |
| Dissolvan 3146-3 | | | | | | | | | |
| EVD 92750 | | | | | | | | | |
| 25 ppm of | 100 | 2 | 3 | 5 | 10 | 28 | 35 | — | 32 |
| Tetronic 150 R1 | | | | | | | | | |
| EVD 92466 | | | | | | | | | |
| 25 ppm of | 90 | 4 | 6 | 8 | 16 | 37 | 42 | — | — |
| EVD 60549 | | | | | | | | | |

*AS = Active substance

Here too, it can be seen that the compound EVD 60549 according to the invention effects both the fastest and the most distinct separation of water in comparison to the known demulsifiers.

### EXAMPLE 5

Various demulsifiers were added to a sample of crude oil and the separation properties were examined. Dissolvan is a resin derived from nonylphenol ethoxylate which has been crosslinked with formaldehyde but is present in a solvent. EVD 60549 is a compound according to the invention based on EDTA, as described in Example 1.
Emulsion: Emlichheim, oil from probe 301/canister 2
   (Crude oil sample of Apr. 6, 2005)
Viscosity: 440 mPa·s (Brookfield Sp. 3/60 rpm/at 52° C.)
Water content: 30% (Distillation method, DIN ISO 3733)
Temperature: 52° C.
Note: The additive (in each case 5% of active substance* in xylene/isopropanol 3:1) was mixed in by means of an overhead mixer after addition. For the assessment

| | | Water separated off (ml) | | | | | | Emulsion [%] | |
|---|---|---|---|---|---|---|---|---|---|
| | *AS | after time [min] | | | | | | after 4 h | |
| Additive | [%] | 10 | 20 | 30 | 60 | 120 | 240 | Residual w | Residual em |

| | | | | | | | |
|---|---|---|---|---|---|---|---|
| Blank | — | 0 | 0 | 0 | 0 | 0 | 1 |
| 25 ppm of | 100 | 0 | 0 | 1 | 1 | 2 | 3 |
| Sepabase A 39 | | | | | | | |
| EVD 57260 | | | | | | | |
| 25 ppm of | 51 | 0 | 0 | 1 | 2 | 2 | 4 |
| Sepabase R 19 | | | | | | | |
| EVD 58490 | | | | | | | |
| 25 ppm of | 45 | 1 | 2 | 3 | 5 | 10 | 14 |
| Dissolvan 3146-3 | | | | | | | |
| EVD 92750 | | | | | | | |
| 25 ppm of | 90 | 1 | 3 | 5 | 9 | 12 | 14 |
| EVD 60549 | | | | | | | |
| 25 ppm of | 90 | 0 | 1 | 1 | 2 | 4 | 5 |
| EVD 60550 | | | | | | | |
| 25 ppm of | 100 | 0 | 0 | 1 | 2 | 5 | 9 |
| Tetronic 150 R1 | | | | | | | |
| EVD 92466 | | | | | | | |

Here too, it can be seen that the compound EVD 60549 according to the invention effects both the fastest and the most distinct separation of water in comparison to the known demulsifiers.

1. A compound of the formula 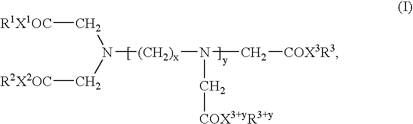
where
x is from 2 to 10,
y is from 0 to 10,
R¹, R², R³, . . . , R^{3+y} each, independently of one another,
—[(EO)ₖ^{(1, . . . , t)}—(Po)ₘ^{(1, . . . , t)}—(BuO)_{n(1, . . . , t)}]ₜ—R^{z},
the indices k^{(1, . . . , t)} in the t sections are each, independently of one another, from 0 to 200,
the indices m^{(1, . . . , t)} in the t sections are each, independently of one another, from 0 to 200,
the indices n^{(1, . . . , t)} in the t sections are each, independently of one another, from 0 to 200,
t is from 1 to 20,
R^{z} is H, alkyl, cycloalkyl, heteroalkyl, heterocycloalkyl, aryl, aralkyl or heteroaryl,
X¹, X², X³, . . . , X^{3+y} are each, independently of one another, —O—, —NH— or
—NR^{z}—,
with the proviso that
when x=2 and y=1,
in at least one R¹, R², R³ or Y, at least one k^{(1, . . . , t)} or n^{(1, . . . , t)} is not 0, und in all other cases, at least one k^{(1, . . . , t)} or m^{(1, . . . , t)} or n^{(1, . . . , t)} is not 0.

2. The compound according to claim 1, wherein, independently of one another,
x is from 2 to 6,
y is from 0 to 5,
the indices k^{(1, . . . , t)} in the t sections are each, independently of one another, from 0 to 100,
the indices m^{(1, . . . , t)} in the t sections are each, independently of one another, from 0 to 100,
the indices n^{(1, . . . , t)} in the t sections are each, independently of one another, from 0 to 100,
t is from 1 to 10,
R^{z} is H or alkyl, cycloalkyl, heteroalkyl, heterocycloalkyl, aryl, aralkyl or heteroaryl having from 1 to 20 carbon atoms,
each X¹, X², X³, . . . , X^{3+y} is —O—, —NH— or —NR^{z}—.

3. The compound according to claim 1, wherein, independently of one another,
x is 2,
y is 0, 1 or 2,
the indices k^{(1, . . . , t)} in the t sections are each, independently of one another, from 0 to 50,
the indices m^{(1, . . . , t)} in the t sections are each, independently of one another, from 0 to 50,
the indices n^{(1, . . . , t)} in the t sections are each, independently of one another, from 0 to 50,
t is from 1 to 5,
R^{z} is H or alkyl, cycloalkyl, heteroalkyl, heterocycloalkyl, aryl, aralkyl or heteroaryl having from 1 to 10 carbon atoms,
X¹, X², X³, . . . , X^{3+y} is —O—.

4. The compound according to claim 1, wherein, independently of one another,
y=1,
the indices k^{(1, . . . , t)} in the t sections are each, independently of one another, from 0 to 30,
the indices m^{(1, . . . , t)} in the t sections are each, independently of one another, from 0 to 30,
the indices n^{(1, . . . , t)} in the t sections are each, independently of one another, from 0 to 30,
t=1, 2 or 3,
R^{z} is H or alkyl having from 1 to 5 carbon atoms.

5. The compound according to claim 1, wherein
a) t=1 and
(i) k¹=0 or
(ii) m¹=0 or
(iii) n¹=0; or
b) t=2 and
(i) k¹=0, m¹ and k² are not 0 or
(ii) k¹ and m¹=0, n¹ is not 0 and k² is not 0 or
k¹ and m¹=0, n¹ is not 0 and m² is not 0.

6. The compound according to claim 1, wherein each k^{(1, . . . , t)} or each m^{(1, . . . , t)} or each n^{(1, . . . , t)}=0.

7. A process for preparing a compound according to claim 1, which comprises reacting a compound of the formula 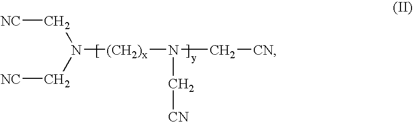
where x and y are as defined in claim 1,
in a first step with R¹—X¹H, R²—X²H, R³—X³H, . . . , R^{3+y}—X^{3+y}H and mineral acid and simultaneously or
in a second step with water or an aqueous base.

8. A process for preparing a compound according to claim 1, which comprises reacting a lower carboxylic ester or a carboxylic acid of the formula 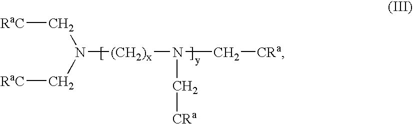
where x and y are as defined in claim 1 and R^{a}═C₁-C₆-alkyl, H, with alkyl polyglycol in the presence of an acid or base as catalyst.

9. The process according to claim 8, wherein the alcohol R^{a}—OH formed, where R^{a}═C₁-C₆-alkyl, is removed by distillation.

10. A method of separating an emulsion comprising adding to the emulsion the compound according to claim 1 and/or a compound in which x=2 and y=1 and in which at least one m^{(1, . . . , t)} in at least one R¹, R², R³ or R^{3+y} is not 0.

11. The method according to claim 10, wherein the emulsion is crude oil.

12. A composition comprising a compound according to claim 1.

13. A kit of parts comprising a composition according to claim 12.

14. A method of separating off water from crude oil, wherein a compound according to claim 1 is used.

15. An oil comprising compounds according to claim 1.

16. (canceled)

17. The compound according to claim 2, wherein, independently of one another,
x is 2,
y is 0, 1 or 2,
the indices k^{(1, . . . , t)} in the t sections are each, independently of one another, from 0 to 50,
the indices m^{(1, . . . , t)} in the t sections are each, independently of one another, from 0 to 50,
the indices n^{(1, . . . , t)} in the t sections are each, independently of one another, from 0 to 50,
t is from 1 to 5,
R^{z} is H or alkyl, cycloalkyl, heteroalkyl, heterocycloalkyl, aryl, aralkyl or heteroaryl having from 1 to 10 carbon atoms,
X¹, X², X³, . . . , X^{3+y} is —O—.

18. The compound according to claim 2, wherein, independently of one another,
y=1,
the indices k^{(1, . . . , t)} in the t sections are each, independently of one another, from 0 to 30,
the indices m^{(1, . . . , t)} in the t sections are each, independently of one another, from 0 to 30,
the indices n^{(1, . . . , t)} in the t sections are each, independently of one another, from 0 to 30,
t=1, 2 or 3,
R^{z} is H or alkyl having from 1 to 5 carbon atoms.

19. The compound according to claim 2, wherein
a) t=1 and
(i) k¹=0 or
(ii) m¹=0 or
(iii) n¹=0; or
b) t=2 and
(i) k¹=0, m¹ and k² are not 0 or
(ii) k¹ and m¹=0, n¹ is not 0 and k² is not 0 or
k¹ and m¹=0, n¹ is not 0 and m² is not 0.

20. The compound according to claim 2, wherein each k^{(1, . . . , t)} or each m^{(1, . . . , t)} or each n^{(1, . . . , t)}=0.

21. A process for preparing a compound according to claim 2, which comprises reacting a compound of the formula 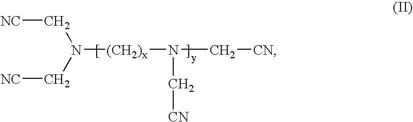
where x and y are as defined in claim 2,
in a first step with R¹—X¹H, R²—X²H, R³—X³H, . . . , R^{3+y}—X^{3+y}H and mineral acid and simultaneously or
in a second step with water or an aqueous base.
